(19) United States
(12) Patent Application Publication
(10) Pub. No.: US 2015/0338104 A1
(43) Pub. Date: Nov. 26, 2015

(54) PORTABLE, FAST BAKING PIZZA STOVE AND RELATED METHODS

(71) Applicant: Adam Lipinski, Pittsburgh, PA (US)

(72) Inventor: Adam Lipinski, Pittsburgh, PA (US)

(21) Appl. No.: 14/659,556

(22) Filed: Mar. 16, 2015

Related U.S. Application Data
(60) Provisional application No. 61/953,830, filed on Mar. 15, 2014.

(51) Int. Cl. F24B 1/02; B23P 19/00; A21D 8/06; A47J 37/07

(52) U.S. Cl. CPC F24B 1/022; A47J 37/0713; B23P 19/00; A21D 8/06

(57) ABSTRACT

Portable stove in which wood can be burned for rapidly baking a plurality of pizzas on a small lot (one, maybe two at a time) basis in five minutes or less. The stove can be broken into sections/segments for transporting to a given site for assembly and use at that site before being disassembled for another use elsewhere. Preferred embodiments include individually leveling legs.

### CROSS-REFERENCE TO RELATED APPLICATIONS

This is a perfection of Provisional Application No. 61/953,830, filed on Mar. 15, 2014, the disclosure of which is fully incorporated by reference herein.

### BACKGROUND OF THE INVENTION

1. Field of Invention

This invention relates to outdoor stoves and more particularly to a portable stove that can quickly assembled and disassembled at a site for use. Once assembled, this stove can be used to burn a consumable fuel, preferably wood, for rapidly baking certain food products like pizzas and breads.

2. Description of Relevant Art

Portable camp stoves that rely on wood and other fuels have been known for years. The prior art has provided a variety of portable stoves for outdoor cooking and heating. Another set of prior art devices are known for igniting and combusting charcoal for heating and outdoor cooking purposes.

Several known prior art grills, charcoal igniters and the like rely on a “flue effect” for drawing in fresh air from below or from sides. After combustion, heated air and combustion gases are emitted through an upper opening or openings. A grate supports solid fuel as it is combusted. That grate allows for circulation of air around the solid-fuel.

Storandt U.S. Pat. No. 3,848,577 is based on the flue effect, but relies on single wall construction and thus does not have a structural member for confining and heating air that can be used in reigniting gases released in primary combustion.

Hoff U.S. Pat. No. 5,363,977 is based on the flue effect. Vents 34 in wall of central member 20 allow air for primary combustion of fuel in barbecue kettle 36. No structural member is depicted for heating confined air, causing it to expand and rise, and to reignite gases released in primary combustion.

Karpina U.S. Pat. No. 4,909,237 discloses a two walled charcoal-maker and starter that is also based on the flue effect. An inner wall forms a loading hopper where charcoal is produced from burning wood in a reduced oxygen environment. An air space between the inner wall of the loading hopper and an outer wall of heat shield 8 intends to protect handle 10 and to prevent the loading hopper from becoming too hot and burning through. The space is used for air circulation, and thus is not intended to heat confined air, causing it to expand and rise, and to reignite gases released in primary combustion.

Williams U.S. Pat. No. 5,230,325 discloses a charcoal lighter device. The body is constructed to employ the flue effect. Air for combustion is drawn through a first series of spaced horizontal air holes 32 extending through a shell adjacent to a bottom in what also serves as a pre-ignition chamber. Fuel is combusted on a grate located above a first series of air holes. Air drawn into a second, similar series of horizontal slots or air holes 34 circulates between two sidewalls. Airspace 44 between the inner and outer sidewalls is designed to promote circulation of air, and is not intended to heat confined air, causing it to expand and rise, and to reignite gases released in primary combustion.

Gillam et al. U.S. Pat. No. 5,425,352 discloses a portable and nest-able grill that relies on the flue effect. Reduced circumference of a waist section, defining a venturi, is noted to increase the velocity of heated air flowing through apertures 38 in restricted orifice of throat 58. Expanding gases are said to magnify convective heat transfer due to swirl and high velocity of an air pattern passing through and around hot coals. Important to note is that this prior art relies on convective heat transfer to aid combustion rate of coals. There is no structural member for heating confined air, causing it to expand and rise, and to reignite gases released in primary combustion.

Other known devices fall into the category of camp and field stoves. These include: Seeley U.S. Pat. No. 936,482, Carpmael UK Patent No. 2475, Ball U.S. Pat. No. 1,238,080, Fairbrother UK Patent No. 117,757, Rhodes U.S. Pat. No. 1,487,474, Ingalls U.S. Pat. No. 1,508,334, French Patent No. 580,829, Swiss Patent No. 11961, German Patent No. 599,185, Steele U.S. Pat. No. 2,517,254, and Kratz U.S. Pat. No. 2,756,738 all rely on liquid fuel combustion devices, such as alcohol (Hartspiritus), gas burners and “Sterno,” that are placed within an enclosure with vents intended to allow for air flow. None of the devices in this group of prior art are designed for combusting solid, ligneous fuels. Nor do those considered include structural members for confining air, heating and inducing its expansion, and then using said air for reigniting gases released in primary combustion.

Yet another category of Solid-Fuel Combusters exists. Among those disclosures are: Milligan U.S. Pat. No. 1,298,762 which teaches a camp stove with a single-walled body that relies on the flue effect. A grate for supporting combusting fuel is located in the lower portion of a stove body, above two rings of air intake vents 5 circumferentially spaced apart. A short distance above the grate is a series of apertures 9 to provide air over the top of a fire to aid its combustion. A series of oblong apertures 10 are adjacent to the top of the stove body to emit combustion gases longitudinally. For burning wood or charcoal, stove's flue body can be turned either up or down, and wire mesh grating 8 that holds combusting fuels can be moved to the upper side of supporting pins 7. The single-bodied flue neither provides a structural member for heating and expanding air in a confining space between two walls, and then introducing it to gases released and ascending with primary combustion. Nor is there an opening for continuous stoking, i.e., by adding fuel without removing a cook pot that is being heated at the stove's top.

Schonitzer U.S. Pat. No. 1,391,415 discloses a field stove with a fire-pot 1 in which solid-fuel such as wood is combusted. Solid-fuel can be stoked in through fire door 2. Schonitzer's device fails to include structural members for confining and heating air so that said air might be used to reignite gases freed in primary combustion.

Perlman U.S. Pat. No. 2,530,721 is intended to spread heat over the larger surface of a can, so as to reduce the burning of contents. Perlman's device disclosed in 1950 is both structurally and functionally similar to his 1952 disclosure, and thus both can be understood and critiqued through the latter disclosure.

Perlman U.S. Pat. No. 2,607,334 discloses a heater or stove that can be set up for use from a collapsed position. Its design provides for introducing solid-fuel when opening 12 is aligned with slide 13, without dismantling the device or interfering with the burning of fuel remaining on a hearth. Air is drawn in though ports 12, adjacent to surrounding walls of the hearth, and passes through a large number of perforations in shell 8. Products of combustion also pass outwardly through openings in the shell.

The vertical dimension of the Perlman shell causes un-ignited products of combustion rising from the hearth to strike the bottom of a can, containing contents to be heated, which acts as a baffle causing the un-ignited products of combustion to spread radially outward and through ports or openings in the baffle. Through inlet openings 15, air is drawn in for primary combustion. While it could be construed that secondary combustion takes place, inlet ports 17 are designed for drawing in air by the force of suction created by the combined forces of combustion and the flue effect. Perlman's device, however, exhibits no structural member for using primary combustion for heating air contained in an adjacent confining airspace, causing it to expand and rise, and to introduce it so as to reignite gases released in primary combustion.

### SUMMARY OF THE INVENTION

It is a principal objective of this invention to provide the wood burning pizza restaurant craze to casual, outdoor settings ranging from small party attendees, to medium sized “crowds” of up to a hundred or more, to even small outdoor events/festivals, such as fairs and the like where individuals are comfortable “waiting in line” for customized food service from a portable vending station. It is another primary objective to allow for individuals, vendors and/or franchisees to bring fast baked pizza to the customer. Rather than supplying a wood-fired pizza made elsewhere and shamefully cooled while being driven to the consumer's destination, this invention will allow the same or better quality pizzas to be made right next to where they will be consumed.

This invention provides an easily assembled, portable stove in which pizzas and breads may be baked/cooked. It consists of several segments, a cooking chamber, fire grate in which fuel, preferably wood (and to a lesser extent coal or gas) is supplied and burned, a chimney stack, firebox and stand. Ideally, the stand includes individually adjustable legs for leveling. A heat resistant, multi-directional level (preferably magnetic) may be added or incorporated herein.

In a less preferred variation, the foregoing can be fitted onto a small pull behind trailer for transporting to a party, catering event and/or campsite for a short useful, “full-filling” stay.

### BRIEF DESCRIPTION OF THE DRAWINGS

Further features, objectives and advantages of this invention will become clearer from the following detailed description made with reference to the accompanying drawings in which:

FIG. 1 shows, in an exploded perspective view, the main elemental components for one embodiment of pizza stove according to this invention prior to assembly, or from top to bottom: a cooking chamber, fire grate, firebox and stove stand;

FIG. 2 shows a top perspective view of the firebox on its stand with its front access door open exposing the fire grate situated inside;

FIG. 3 shows a close up view of the underside to a cooking chamber laid on its rear edge with its front assembly extending upwardly;

FIG. 4 shows, in front view, a fully assembled and ready for baking stove unit per one embodiment with the firebox and cooking chamber doors open;

FIG. 5 shows a front perspective view of the assembly with doors closed and a full view of the flue pipe with an optional rain cap thereover; and

FIG. 6 shows a rear perspective view of the fully assembled stove unit from FIG. 5.

### DETAILED DESCRIPTION OF PREFERRED EMBODIMENTS

With regard to the accompanying FIGS, there is shown one preferred embodiment of fast-baking pizza stove according to this invention. As the taste and sensation of a wood-fired food product has become a recent popular phenomenon, this invention attempts to bring end product (closer) to the end consumer. Whether at a campground, backyard deck or rear porch, this easy-to-transport and assemble stove unit can be used for rapidly making and then baking one pizza pie at a time, up to 12-14″ in diameter, or several loaves of bread/buns raising in a pan or two. This invention enables one individual, alone, to make and bake customized pizza pies right at the point of “sale”/consumption.

With modification, it may be possible to cook two smaller pies together but considering how short baking time is WITH this device (i.e. about 2 minutes per pie), a “one-size” approach is preferred and, admittedly, more intimate.

These units can be sold, leased or rented, A unit may be franchised by a pizza maker/provider to do as part of a bigger restaurant-style service providing “package”, or possibly even affixed to a small pull-behind trailer for transporting to and from an end user, pie-baking location like a backyard party, street fair or the like.

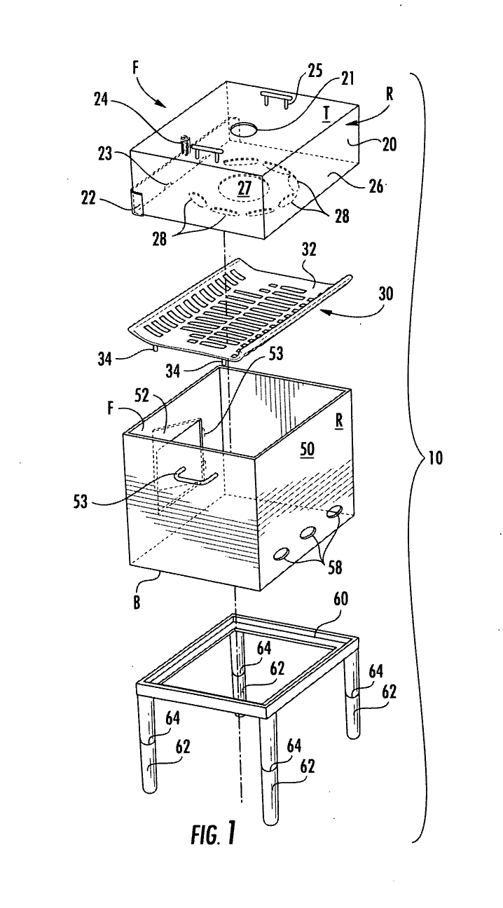

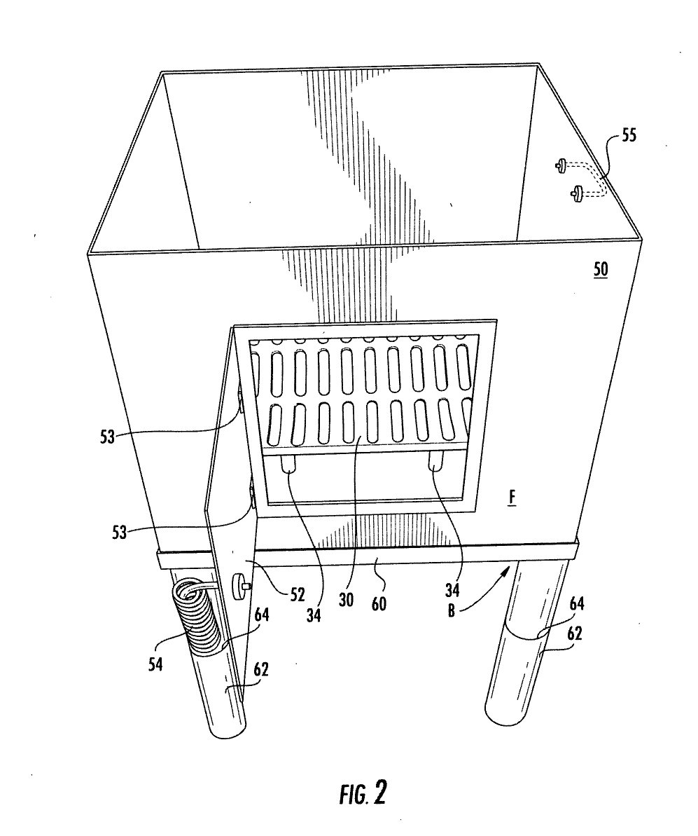

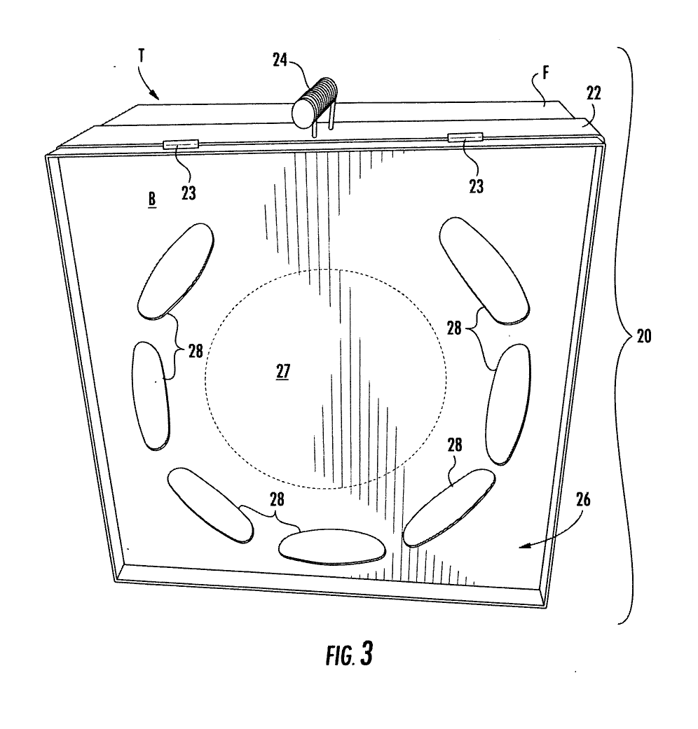

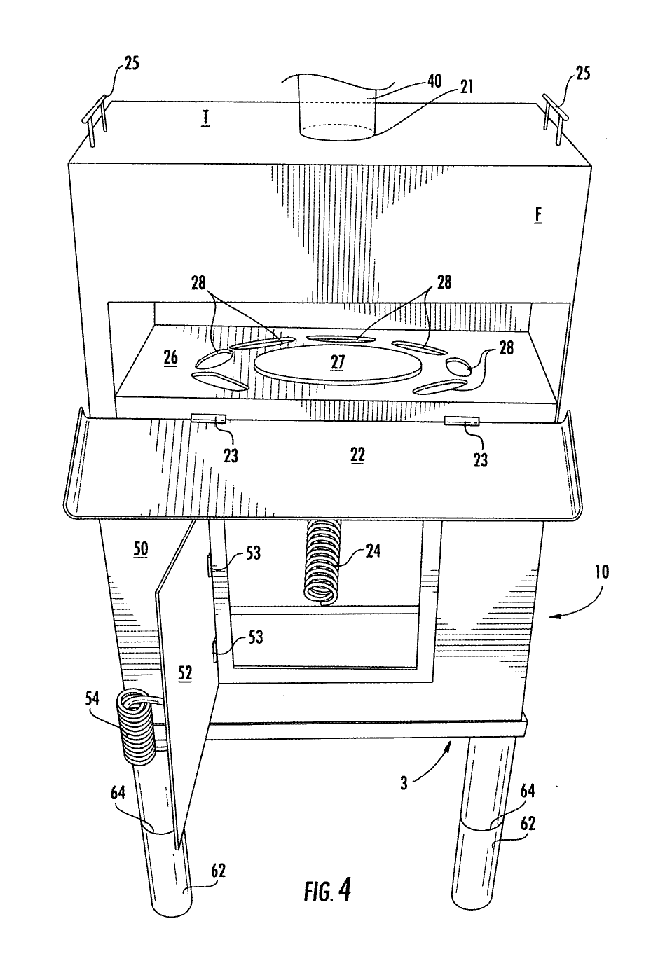

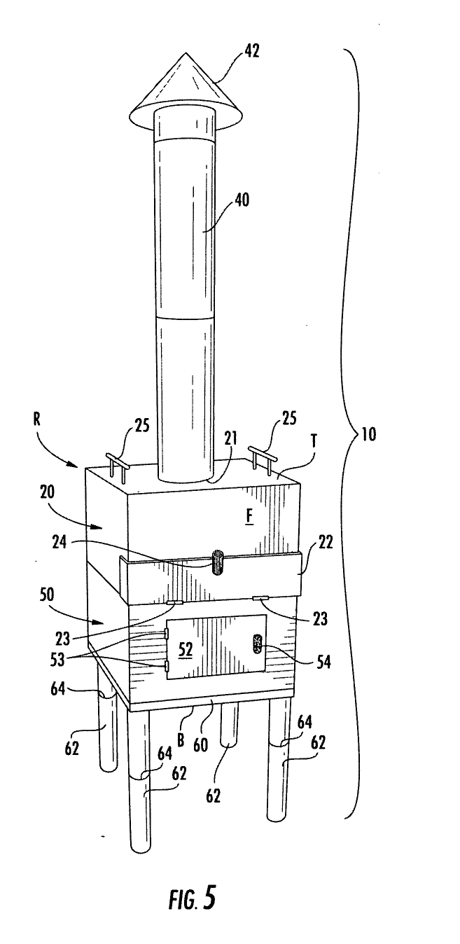

As for the respective component parts, they are shown (less the flue pipe) in FIG. 1 as they would appear when broken down (or dis-assembled) for transport to a remote assembly location. More specifically, a single pizza stove unit 10 would include: a cooking chamber 20 (as better seen on its front end/edge in accompanying FIG. 3), a fire grate 30 (FIGS. 1 and 2, purposefully removed from view in FIG. 4), a multi-section, chimney stack 40 (FIGS. 4 through 6), firebox 50 and stove stand 60 (both in FIGS. 1-2, 4-6).

In FIG. 1, the aforementioned components (less the flue or stack 40) are shown in an exploded view, from top to bottom. These main components stack together to form: (i) a portable; (ii) easily transportable; and (iii) assembl-able at the site of use, (iv) fast-baking pizza oven. This invention requires no electric hookups to assemble and/or operate. When supplied with a fuel of choice, it can fully bake a pizza pie every 2-3 minutes . . . during which time a single oven operator has sufficient time to “dress” the next pizza pie shell (pre-made, or hand-tossed) with sauce and customized topping combinations requested by the subsequent consumer standing/partying nearby.

Pizza stove 10 comprises a cooking chamber 20 with its own top exit port 21, front access door 22, with hinges 23 and door handle 24, a pair of carrying handles 25, an internal cooking surface 26 with a central pizza stone 27 surrounded by a plurality of apertures 28 through which heat may enter from below and circulate about said chamber 20.

Stove 10 further includes a fire grate 30 with a top surface 32 for holding a fuel source (preferably wood; alternately, coal) and plurality of grate legs 34. Connecting to the top exit port 21 of cooking chamber 20 will be a multi-sectioned chimney stack 40 with its optional rain cap 42. All of the foregoing rests on a firebox 50 (with its own front access door 52, hinges 53 and handle 54) with its own set of venting holes or apertures 58. Firebox 50 sits directly on its own stove stand 60 with four corner legs 62. On a preferred basis, at least two and preferably all four of said legs include an adjustable height leveler 64.

In the model depicted in FIG. 3, a flagpole holder-looking adapter A extends from a back end of cooking chamber 20. That adapter A holds angled piping that can used for bending at a first ninety degree angle before bending back at a second right angle for preventing any (rain) water from reaching pizzas baking in the cooking chamber or otherwise dousing the heat emanating from the wood (or other fuel) in the firebox beneath said cooking chamber. Alternately, if a heavy storm was forecast before the party was scheduled to start, the whole unit 10 could be set up under a porch, tent or temporary canopy of some sort.

On average, it should take about 10-15 minutes to stack the components and connect them together. Once arranged and stacked, the assembled unit need not be mechanically joined any further as the assembly is NOT meant to be permanent. Rather, the “stand” will be held together by its own weight. Fully stacked, the entire unit will weigh roughly 250 to 300 pounds, extend about 4 to 5 feet high and have a baking firebox that is about 24×24 inches in diameter.

Unlike some of the small campfire (heating) stoves of the prior art, this invention can accommodate full size logs in its “firepit”—and typically heat a fully prepared pizza shell to a serving temperature of about 450 or 500° F., up to about 850° F. in less than 5 minutes, actually more like about one and a half to three minutes per pizza pie. For some breads, baking time in a properly pre-heated oven can take a bit longer; they will usually have to sit under a 3″ tall loaf or less. During the whole time of “use”, outdoors immediately adjacent a campground, deck or outside party, neighbors will all reap the benefits of these freshly made pizza/bread smells!

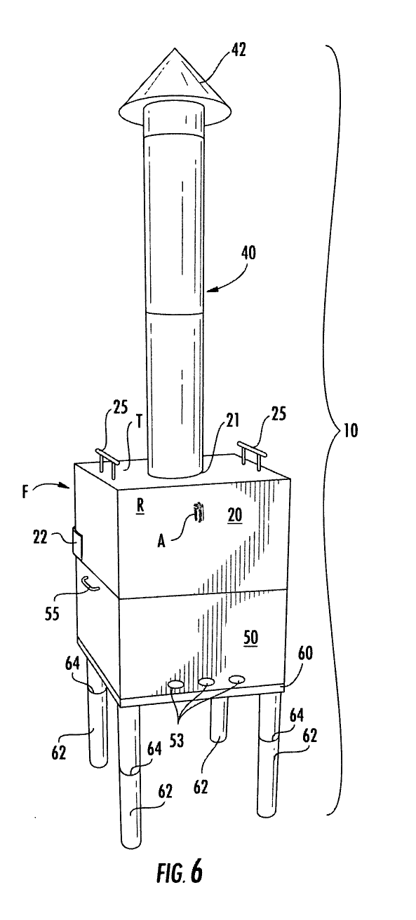

In the model depicted in FIG. 6, there is shown a flagpole holder-looking adapter A that extends from a rear end R of the cooking chamber. That adapter serves as a supplemental stand/holder support for a pair of right angled flue pipes, should the assembled unit need to angle about a deck roof or other “permanent” outside structure. In most instances, however, it is recommended that a standard, straight flue configuration be employed. Height restrictions usually are not a problem for most outdoor baking setups.

Still other options would include: separately adjustable leg height levelers L should the assembling surface be the least bit uneven. A built in, temperature resistant level (not shown) may be added optionally, as well as a high temperature thermometer that can magnetically attach to a side of the firebox and/or cooking chamber.

The baking chamber can be fitted with a solid 15″ pizza stone (baking surface). While removal for cleaning, more deluxe versions may include an optional, rotatable stone, one that can be manually spun, or possibly mechanically rotating within the cooking chamber for better, all around rapid baking of each pie placed thereon.

When baking is complete, the whole assembly could be kept intact for a bit longer to warm the party attendees as a pseudo-chiminea. Alternately, it could be allowed to completely cool down, taking no more than about 45-60 minutes to sufficiently cool for disassembly and transfer to the back of an SUV or pickup flatbed. Total cooling time depends on how fast the fuel source (coals/firewood) can be removed from the unit, transported in a metal bucket and safely doused out so as to not create any risk of re-ignition later.

This “in situ” wood fire pizza baker permits an acceptable degree of control over temperatures within and above its combustion chamber. It is contemplated that this stove can be made in several varieties of sizes and dimensions. Its outer box could also other than square-shaped, such as a fancier-looking octagonal or semi-rounded variation.

If intended for other than outdoor use, a longer set of flue connections must be arranged for proper smoke venting and temperature dissemination.

Before assembly and after cooling and disassembly, it is meant for the various component parts to be carried to a set up site. In other words, the sub-elements can be brought by one or two folks, perhaps in just a few trips, for assembling at the ultimate pie-baking destination for the evening.

Main components of this stove can be manufactured from readily available materials, preferably metal, and more particularly steel or cast iron. To a lesser degree, other fancier looking alternatives may be substituted for one or more elements or used to embellish/adorn one or more sections—for aesthetic purposes. For instance, copper, aluminum, ceramic materials, and a host of man-made materials can be used.

Thus the scope of the invention should be determined by the appended claims and their legal equivalents, rather than by the examples given.

What is claimed is:

1. A portable, fast baking pizza stove comprising: a cooking chamber having a top exit port, a fire grate, a chimney stack, a firebox and a stove stand, said pizza stove being capable of: quick assembly at a first location, use for baking pizzas therein in less than five minute frequencies, disassembling after cool-down and reassembling at a second location for another round of pizza baking.

2. The pizza stove of claim 1 wherein the firebox is intended to hold and be restocked with a wood fuel source.

3. The pizza stove of claim 1 wherein the firebox is intended to hold and be restocked with a coal-based fuel source.

4. The pizza stove of claim 1 wherein the firebox is modified to receive burnable gas from an outside supply.

5. The pizza stove of claim 4 wherein the outside supply is a portable propane tank

6. The pizza stove of claim 1 wherein the cooking chamber, the chimney stack, the firebox and the stove stand are stacked together by weight and not permanently connected together.

7. The pizza stove of claim 1 wherein the stove stand includes at least two individually adjustable leg levelers.

8. The pizza stove of claim 1 wherein the cooking chamber includes a pizza stone onto which individual pizzas are placed for baking.

9. The pizza stove of claim 8 wherein the pizza stone can be manually rotated.

10. A method for assembling a portable, fast baking pizza stove at an outdoor location for baking a plurality of pizzas in the assembled pizza stove for prompt consumption thereafter, said method comprising: (a) providing a stove stand onto which is temporarily rested a firebox, then a cooking chamber atop the firebox, said cooking chamber having a top exit port; (b) inserting a fire grate into said cooking chamber; and (c) connecting a chimney stack to the top exit port of the cooking chamber, said pizza stove being capable of baking pizzas therein in less than five minute frequencies.

11. The method of claim 10, which further comprises adding a burning fuel to the firebox.

12. The method of claim 11 wherein the burning fuel is sections of wood.

13. The method of claim 11 wherein the burning fuel is coal.

14. A method for rapidly baking and serving a plurality of wood-fired pizzas at an outdoor function, said method comprising: (a) assembling a pizza stove by stacking together its component parts consisting of: (i) a stove stand onto which is temporarily rested (ii) a firebox, then (iii) a cooking chamber atop the firebox, said cooking chamber having a top exit port to which is connected (iv) a chimney stack; (b) inserting a fire grate into said cooking chamber and adding a supply of wood fuel to the fire grate; (c) heating the wood fuel within the firebox to keep the cooking chamber at a minimum temperature of about 450° F.; (d) preparing a first pizza and placing it in the heated cooking chamber to bake for less than five minutes; and (e) while the first pizza is baking, preparing a second pizza to insert into the cooking chamber after the first baked pizza is removed therefrom.

15. The method of claim 14 wherein the cooking chamber is kept at a temperature between about 500 and 850° F.

16. The method of claim 14, which further comprises: when all the pizzas have been made, baked and served at the outdoor function: (f) emptying the wood fuel from the firebox; (g) allowing the pizza stove to adequately cool; and (h) disassembling the pizza stove for transport and use at a second outdoor function.

17. The method of claim 14, which further comprises: transporting the pizza stove component parts to the outdoor function on a towable trailer.

18. The method of claim 17 wherein the pizza stove component parts are assembled for use on the towable trailer to bake pizzas therein.

19. The method of claim 14 wherein a plurality of pizzas are made and baked in said pizza stove at intervals of less than about three minutes.

20. The method of claim 19 wherein each successive pizza is customized with an individual's requested toppings while a preceding pizza is being baked in the pizza stove.
